(19) United States
(12) Patent Application Publication
(10) Pub. No.: US 2001/0014261 A1
(43) Pub. Date: Aug. 16, 2001

(54) FLEXIBLE CORRUGATED HOSE AND METHOD AND TOOL FOR REDUCING NOISE THERIN

(76) Inventor: EDWARD ROMERO, EL PASO, TX (US)

Correspondence Address: EDWARD ROMEO, 4429 SLEEPY WILLOW, EL PASO, TX, 79922, US

(21) Appl. No.: 09/374,433

(22) Filed: Aug. 13, 1999

(51) Int. Cl. B23D 5/02

(52) U.S. Cl. 409/306; 409/261; 409/307

(57) ABSTRACT

A tool for creating grooves or cut-away portions in the inwardly extending corrugations of a flexible corrugated hose in order to eliminate noises created by movements of fluids, such as air, through the interior passage of the hose. The tool is a generally cylindrical member having outwardly extending fins extending at an angle to the longitudinal direction thereof. The tool is placed within the hose and relative movement in an axial or longitudinal direction causes the fins to act as cutting members and create the grooves or cut portions. The movement causes the fins to create an angled pattern of grooves relative to the axial direction.

### BACKGROUND OF THE INVENTION

1. Field of the Invention

This invention relates to a flexible corrugated hose having inwardly extending corrugations for conveying fluids, such as air under pressure or vacuum. In order to reduce or minimize the whistling noises which occur during passage of the fluid through the hose, a tool is used to change the configuration of the interior of the hose.

2. Prior Art Statement

Flexible corrugated tubing or hose may be manufactured by various known methods, such as by blow molding. A typical product is shown for example in U.S. Pat. No. 3,605,817, issued to Bauman et al. Bauman et al. Recognized the whistling problem created by movement of air in tubing, and formed projections or indentations in the inwardly extending corrugations to roughen the interior surface of the hose, thus attenuating the whistling noises. This was done by providing the die blocks used in manufacturing the hose with special sections that create the projections or indentations during the manufacture of the hose.

### SUMMARY OF THE INVENTION

The present invention provides for a device or tool for treating a flexible corrugated hose or tubing after its initial formation, in order to minimize or even eliminate noises, such as whistling, created by passage of fluids within the hose or tubing. This product may be used for such applications as vacuum cleaners or swimming pool equipment, and it is this air movement that may cause the whistling. The hose or tubing may be formed by conventional blow molding processes, such as in the aforementioned Bauman et al. U.S. Pat. No. 3,605,817, which disclosure is hereby incorporated by reference. The resulting product is defined by extrusion of a material such as polyvinyl chloride to form a non-reinforced product having outwardly and inwardly extending corrugations. In contrast to the teaching of Bauman et al, where indentations are simultaneously formed by protuberances or indentations in the die blocks, the present invention forms grooves created by cutting away portions of the pre-formed inwardly extending corrugations using a special cutting tool. The tool is moved in a longitudinal or axial direction relative to the hose, or the hose may be moved in the longitudinal direction relative to the tool. The tool has angled, outwardly extending fins acting as cutting members to create the grooves in the corrugations. These grooves provide a rough surface on the innermost portions of the inwardly extending corrugations to disrupt the laminar flow of air that creates the unwelcome noise. The fins, separated by valleys, extend at an angle of 10 to 16 degrees, preferably approximately 14 degrees, to the longitudinal axis of the hose to create an aligned angled pattern in the inner surfaces of the corrugations of the hose with respect to the longitudinal axis thereof.

It is a principal object of this invention to provide a tool or device for roughening the inner surface of a flexible corrugated hose.

It is a further object to specifically roughen the innermost portions of the inwardly extending corrugations of the hose.

It is another object to utilize the roughening to minimize noises created by passage of fluid within the hose.

It is another object to achieve the roughening by relative movement between the tool and hose in a longitudinal direction.

It is a further object to form the tool with angled cutting members to provide grooves in the corrugations.

It is a further object to create a longitudinally angled pattern of grooves during the relative movement between the hose and the tool.

These and other objects and features will be apparent from the embodiments described and shown herein.

### BRIEF DESCRIPTION OF THE DRAWINGS

FIG. 1 is a side view of the tool and a typical hose, used to create the cut-away portions in the hose, relative to and prior to engagement with the hose.

FIG. 2 is a sectional view of the tool of FIG. 1, taken along lines 2-2.

FIG. 3 is a side view of the hose in partial cross-section after passage of the tool therethrough.

FIG. 4 is a section taken along the line 4-4 of FIG. 3, enlarged to show the cut portions of the corrugations.

FIG. 5 is a view similar to FIG. 3 of a modified form of hose.

### DESCRIPTION OF PREFERRED EMBODIMENTS

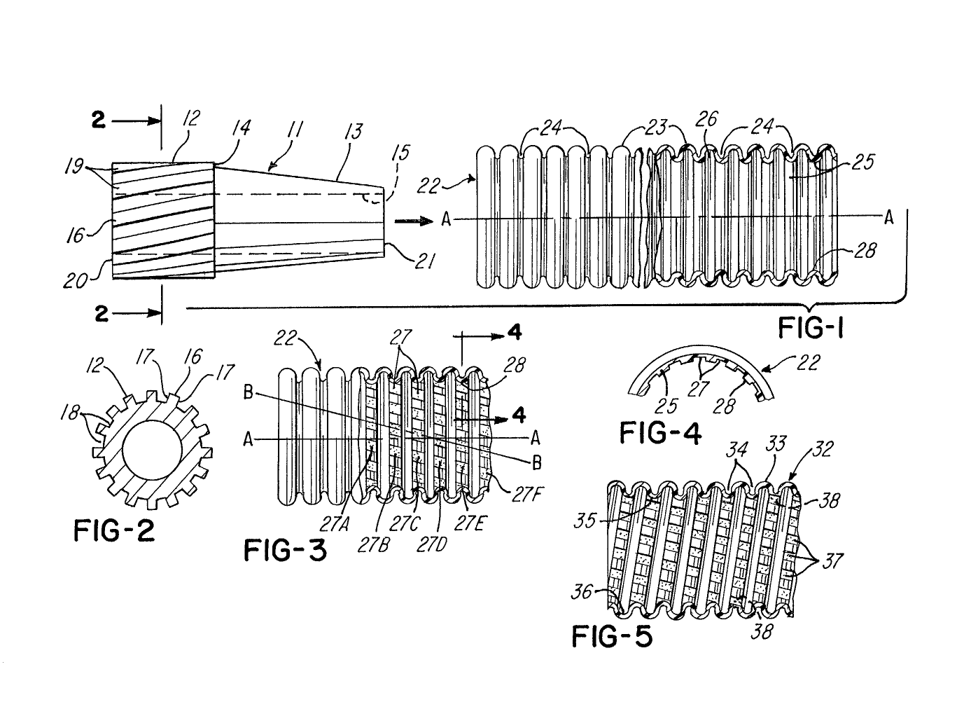

Referring now to the drawings, the novel tool or device 11 is shown in FIGS. 1 and 2. The tool is generally cylindrical and is preferably made of a metal, such as steel, as shown in FIGS. 1 and 2, but may be made of a hard plastic material such as nylon or ABS. The tool has a cylindrical portion 12 and a tapered portion 13 integral therewith and extending longitudinally from the portion 12, with a shoulder 14 between these portions. An opening 15 extends through the center of portions 12 and 13. The portion 12 has a plurality of parallel lines 19 extending outwardly therefrom and extending longitudinally of the tool. The fins are radially spaced around the outer surface, at an angle of approximately 10 to 16 degrees to the longitudinal axis of the tool, with a 14 degree angle being preferred. In the typical embodiment of FIGS. 1 and 2, sixteen of these fins are shown, but this number may be changed in accordance with the various types of hoses to be processed. Each of the fins shown have a band 16 forming the outer surface of portion 12, and is about 0.094 inches wide and has a depth of 0.055 inches. As shown, the fins are generally rectangular and are defined by sides 17 and are separated by the valleys 18. The fins provide the cutting means, and thus the outside diameter of the portion 12, corresponding to the outer surface of the bands, is designed to be slightly greater than the inner diameter of the hose to be processed. For example, if the inner diameter of the hose 22 (at the inwardly extending corrugations) is 0.860 inches, the outside diameter of the portion 12 may be 0.870 inches, thus providing for a cut of 0.005 inches in the innermost portion of the hose. The depth of the cut may be varied by changing the outside diameter of the portion 12 as desired and is generally about 0.01 to 0.06 inches in depth.

As shown in FIG. 1, the hose 22 may be held in place and the tool 11 moved longitudinally through the hose; along the axis A-A or optionally, the tool may be held in a fixture and the hose moved longitudinally over the tool. These functions may be provided by mechanisms well known in the art. The hose 22 is formed with longitudinally spaced annular convolutions having outer corrugations 23, forming valleys 24 in the outer surface of the hose; and inwardly extending corrugations 25 forming inner surface valleys 26. As the tool is moved from the end 21 of the tapered portion 13 toward the end 20 of the portion 12 through the hose, the edges of the fins at the shoulder 14 cut into the innermost portions 28 of the inwardly extending corrugations 25 to create grooves or cut portions 27 therein formed by cutaway segments 38. This is shown in an enlarged view in FIG. 4. As shown in FIG. 3, each groove in the corrugations is aligned in a longitudinally angled direction with the corresponding grooves in the succeeding corrugations, so that all grooves are arranged in an angled line B-B with respect to the longitudinal axis A-A of the hose. This pattern is created by the angled arrangement of the fins 19. It has been found that this pattern is the most efficient manner of disrupting the laminar flow and reducing the objectionable whistling noises. As an example of the relationship of the grooves in line B-B, the grooves are designated as 27A, 27B, 27C, 27D, 27E and 27F. The line B-B is between 10 to 16 degrees, preferably 14 degrees, with respect to axis A-A, as defined by the angle of the fins of tool 11.

FIG. 5 is a representation of a modification of the hose of FIG. 3, wherein the hose 32 has convolutions which are in the form of a continuous helix rather than the annular corrugations of FIG. 3. Thus, the outer corrugations 33 define valleys 34 in the outer surface, and inwardly extending corrugations 35 define inner valleys 36. This hose is subjected to the same procedure described above with reference to FIGS. 1-4, and results in the formation of grooves 37 in the innermost portion of corrugations 35.

As an alternative method, a thrust bearing may be mounted on the end 20 of the tool so that the tool is free to rotate about its longitudinal axis. In this instance the relative motion between the tool and the hose causes the tool to rotate about its axis and create a somewhat different cutting effect in the innermost portion of the corrugations of the hose, the alignment being helical with relation to the longitudinal axis of the hose.

The embodiments shown herein should be understood to be exemplary and other modifications are understood to be within the spirit of the invention.

What is claimed is:

1. In a flexible elastomeric hose having a longitudinal axis and a fluid conveying passage and comprising corrugations extending inwardly into said passage; the improvement comprising means for reducing noises produced by movement of said fluid through said passage, said means comprising grooves formed by cutting away segments of at least some of the innermost portions of said inwardly extending corrugations.

2. The hose of claim 2 wherein said grooves are aligned in said corrugations at an angle to said longitudinal axis.

3. The hose of claim 1 wherein said grooves extend along the entire length of said hose.

4. The hose of claim 1 wherein each of said grooves in a first corrugation is aligned with corresponding grooves in succeeding corrugations.

5. The hose of claim 2 wherein said aligned grooves are at an angle of 10 to 16 degrees with respect to said longitudinal axis.

6. The hose of claim 2 wherein said aligned grooves are at an angle of approximately 14 degrees with respect to said longitudinal axis.

7. The hose of claim 1 wherein said grooves have a depth of 0.01 to 0.06 inch.

8. The hose of claim 1 wherein said corrugations are annular.

9. The hose of claim 1 wherein said corrugations are helical.

10. A tool for forming noise-reducing means in a flexible elastomeric hose having a fluid conveying passage and comprising corrugations extending inwardly into said passage, said tool comprising a generally cylindrical body adapted for movement within said passage, said body having means on its outer surface adapted for cutting into at least some of the innermost portions of said corrugations to form said noise-reducing means.

11. The tool of claim 10 wherein said cutting means comprises a plurality of longitudinally extending parallel fins separated by valleys, said fins radially spaced around said outer surface.

12. The tool of claim 11 wherein said fins are at an angle of 10 to 16 degrees with respect to the longitudinal axis of said tool.

13. The tool of claim 11 wherein said fins are at an angle of approximately 14 degrees with respect to the longitudinal axis of said tool.

14. The tool of claim 10 wherein said fins are generally rectangular in cross-section.

15. The tool of claim 10 wherein said tool has an outside diameter larger than the diameter of said innermost portion of said inwardly extending corrugations in order to form grooves in said portions.

16. In a flexible elastomeric hose having a fluid conveying passage and comprising corrugations extending inwardly into said passage, a method of reducing noises produced by movement of said fluid through said passage comprising the steps of forming grooves in the innermost portions of at least some of said corrugations, said forming step comprising the cutting of segments in said at least some of said innermost portions.

17. The method of claim 16 comprising the further step of aligning said grooves in an angular alignment with respect to the longitudinal axis of said hose.

18. The method of claim 17 comprising aligning said grooves at an angle of approximately 14 degrees with respect to said longitudinal axis.

19. The method of claim 16 comprising the step of forming said grooves to a depth of 0.01 to 0.06 inch.

20. The method of claim 16 comprising the step of placing said tool within said fluid conveying passage of said hose and providing relative movement between said tool and said hose in a longitudinal direction to create said cutting step.
